(19) United States
(12) Patent Application Publication
(10) Pub. No.: US 2019/0124578 A1
(43) Pub. Date: Apr. 25, 2019

(54) MOBILITY MANAGEMENT ENTITY AND METHOD OF DETERMINING HANDOVER UNDER EVOLVED PACKET CORE NETWORK

(71) Applicant: Institute For Information Industry, Taipei (TW)

(72) Inventors: Ta-Chun NIEH, Taipei City (TW); Jen-Hui CHEN, New Taipei City (TW)

(21) Appl. No.: 15/799,411

(22) Filed: Oct. 31, 2017

(30) Foreign Application Priority Data
Oct. 23, 2017 (TW) 106136346

(51) Int. Cl. H04W 36/30; H04W 36/32

(52) U.S. Cl. CPC H04W 36/30; H04W 36/32

(57) ABSTRACT

Embodiments of the present invention relate to a mobility management entity and a method of determining handover under an Evolved Packet Core Network. The mobility management entity receives signal-to-noise ratio (SNR) information provided by a user equipment with respect to a target base station. The mobility management entity defines a received signal strength indicator (RSSI) and a movement velocity indicator for the user equipment and the target base station according to the SNR information, and determines whether to hand over the user equipment from a serving base station to the target base station according to both of the received signal strength indicator and the movement velocity indicator.

### PRIORITY

This application claims priority to Taiwan Patent Application No. 106136346 filed on Oct. 23, 2017, which is hereby incorporated by reference in its entirety.

### FIELD

Embodiments of the present invention relate to a mobility management entity and a method of determining handover. More particularly, embodiments of the present invention relate to a mobility management entity and a method of determining handover under an Evolved Packet Core Network.

### BACKGROUND

Handover is an essential mechanism in various mobile communication systems. For example, when a user equipment moves away from the coverage of a serving base station, a handover mechanism switches data and controlling of the user equipment from the serving base station to a target base station at proper time so as to prevent interruption of the communication with users. As another example, when the serving base station is overloaded, a handover mechanism offloads all or part of the data of the user equipment from the serving base station to the target base station at proper time while the user equipment is still under the control of the serving base station, thereby reducing the load of the serving base station and/or improving the communication quality.

The implementation of the aforesaid handover effect is dependent on whether the handover is successful and beneficial, and whether the handover is successful and beneficial generally depends on methods of determining handover. Conventional handover mechanisms usually determine whether to hand over simply according to a strength or signal-to-noise ratio (SNR) of a signal received from the target base station by the user equipment. However, in reality, factors influencing whether the handover is successful and beneficial not only comprise the strength of the received signal, so the conventional handover mechanisms are often faced with problems such as a high handover failure rate or a wrong handover (i.e., the handover is successful but is not beneficial). Accordingly, an urgent need exists in the art to provide a more practical method of determining handover.

### SUMMARY

In order to solve at least the aforesaid problem, some embodiments of the present invention include a mobility management entity under an Evolved Packet Core Network. The mobility management entity may comprise a transmission device and a computing device electrically connected with the transmission device. The transmission device may be configured to receive signal-to-noise ratio (SNR) information provided by a user equipment with respect to a target base station. The computing device may be configured to define a received signal strength indicator (RSSI) and a movement velocity indicator for the user equipment and the target base station according to the SNR information, and determine whether to hand over the user equipment from a serving base station to the target base station according to both of the received signal strength indicator and the movement velocity indicator.

In order to solve at least the aforesaid problem, some embodiments of the present invention include a method of determining handover under an Evolved Packet Core Network, and the method of determining handover may comprise:

receiving, by a mobility management entity, signal-to-noise ratio (SNR) information provided by a user equipment with respect to a target base station;

defining, by the mobility management entity, a received signal strength indicator (RSSI) and a movement velocity indicator for the user equipment and the target base station according to the SNR information; and

determining, by the mobility management entity, whether to hand over the user equipment from a serving base station to a target base station according to both of the received signal strength indicator and the movement velocity indicator.

In the aforesaid embodiments, the mobility management entity may define the received signal strength indicator and the movement velocity indicator for the user equipment according to the SNR information of the target base station, and determine whether to hand over the user equipment from a serving base station to a target base station according to both of the received signal strength indicator and the movement velocity indicator. The received signal strength indicator may be used to determine whether the signal strength of the target base station is good enough to stably maintain the connection between the target base station and the user equipment after the handover, thereby preventing the user equipment from being handed over to a base station of which the signal strength is excessively low. Additionally, the movement velocity indicator may be used to determine whether the movement velocity of the user equipment can keep the user equipment in the coverage of the target base station within a period of time so as to prevent the user equipment from being handed over back to the serving base station or handed over to other base stations within a short period of time after being handed over to the target base station (i.e., the ping-pong effect), which would otherwise cause the waste of handover resources (i.e., without handover benefits). Therefore, in addition to the strength of the signal received by the user equipment from the target base station, the mobility management entity further takes the movement velocity of the user equipment into consideration when determining whether to hand over. Therefore, as compared to the conventional handover mechanism, the aforesaid embodiments provide a more practical method of determining handover.

In some embodiments of the present invention, the mobility management entity may further define other types of indicators in addition to the received signal strength indicator and the movement velocity indicator, and determine whether to hand over the user equipment from the serving base station to the target base station according to all the indicators being defined. For example, the mobility management entity may further define an access delay indicator, and determine whether to hand over the user equipment from the serving base station to the target base station according to the received signal strength indicator, the movement velocity indicator and the access delay indicator, wherein the access delay indicator may be used to determine a delay time of accessing the target base station by the user equipment so as to prevent the user equipment from accessing an inefficient base station.

This summary overall describes the core concept of the present invention and covers the problem to be solved, the means to solve the problem and the effect of the present invention to provide a basic understanding of the present invention by a person having ordinary skill in the art. However, it shall be appreciated that, this summary is not intended to encompass all embodiments of the present invention but is provided only to present the core concept of the present invention in a simple form and as an introduction to the following detailed description.

### BRIEF DESCRIPTION OF THE DRAWINGS

FIG. 1 illustrates a mobile communication system in one or more embodiments of the present invention;

FIG. 2 illustrates another mobile communication system in one or more embodiments of the present invention;

FIG. 3 illustrates a method of determining handover in one or more embodiments of the present invention; and

FIG. 4 illustrates a method of determining handover under an Evolved Packet Core Network in one or more embodiments of the present invention.

### DETAILED DESCRIPTION

Example embodiments of the present invention described hereinafter are not intended to limit the present invention to any specific example, embodiment. environment, applications, structures, processes or steps described in these example embodiments. In the attached drawings, elements unrelated to the present invention are omitted from depiction; and dimensions of elements and proportional relationships among individual elements in the attached drawings are only exemplary examples but not intended to limit the present invention. Unless stated particularly, same (or similar) element symbols may correspond to same (or similar) elements in the following description.

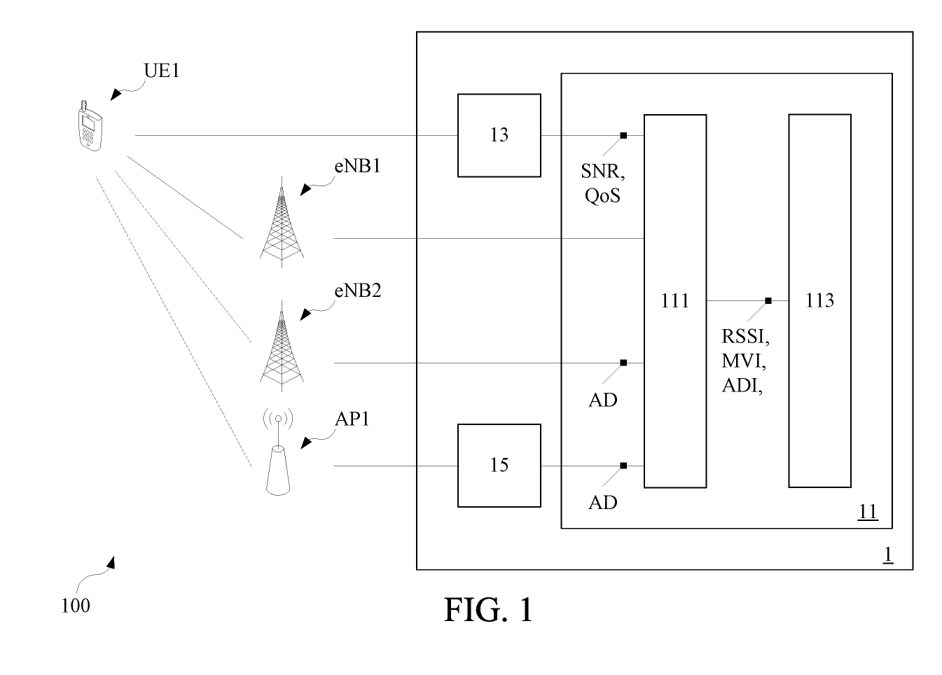

FIG. 1 illustrates a mobile communication system in one or more embodiments of the present invention. However, contents shown in FIG. 1 are only for purpose of illustrating embodiments of the present invention instead of limiting the present invention. Referring to FIG. 1, a mobile communication system 100 may comprise an Evolved Packet Core Network 1, a base station eNB1, a base station eNB2, a base station AP1 and a user equipment UE1.

The Evolved Packet Core Network 1 may be a core network in various mobile communication systems under a 3^{rd} Generation Partnership Project (3GPP). This type of core network is designed as a multiple access core network based on Internet Protocol (IP), e.g., a 3GPP wireless access network (LTE, 3G, 2G), a non-3GPP wireless access network (HRPD, WLAN, WiMAX) and a fixed access network (Ethernet, DSL, Cable, Fiber), thereby increasing the compatibility and coverage rate of the system, reducing the operational cost, and meanwhile increasing the user transmission rate and reducing the delay. Additionally, main constitute elements of this type of core network generally may comprise a mobility management entity (MME), a serving gateway (S-GW), a packet data network gateway (PDN GW) and a home subscriber server (HSS), and these constitute elements cooperate with each other to provide a stable IP connection channel for the user terminal. The base station eNB1 and the base station eNB2 may be base stations in various mobile communication systems under the 3GPP, while the base station AP1 may be a base station in various mobile communication systems under the non-3GPP. Additionally, for the Evolved Packet Core Network 1, the base station AP1 may be a trusted base station. For ease of description, elements in the Evolved Packet Core Network 1 that are not directly related to embodiments for explaining the present invention are omitted from depiction, but this does not mean that the Evolved Packet Core Network 1 does not comprise other elements that have not been described.

Referring to FIG. 1, in addition to other elements, the Evolved Packet Core Network 1 may further comprise a mobility management entity 11, an access network discovery and selection function (ANDSF) device 13 and a packet data network gateway 15.

Like a general mobility management entity, the mobility management entity 11 as a commander of the Evolved Packet Core Network 1 is configured to: coordinate the gateway and the home subscribe server in the Evolved Packet Core Network 1, including managing the Attachment and Detachment of the mobile phone users; perform security-related authentication, authorization and charging for the user terminal; establish, alter or remove EPS bearer for transmitting user data packets; and manage and control mobile roaming of the user terminal, including the handover between the base stations (eNode-B) and tracing of the position and calling of the user terminal in the idle mode.

The mobility management entity 11 may be a single entity or an aggregation, and generally speaking, the mobility management entity 11 may comprise a transmission device 111 for exchanging data and controlling instructions and a computing device 113 for calculating and storing data and generating instructions. For example, the transmission device 111 and the computing device 113 may be implemented by various types of servers which may comprise portions such as a processor, a storage, an input/output interface and a network interface or the like.

The processor may be programmed to interpret various instructions, and then process data in the server and execute various operational programs. The storage may comprise primary memories (which are also called main memories or internal memories), and the memories at this level directly communicate with the processor. The processor may read instruction sets stored in the memories, and executes these instruction sets if needed. The storage may further comprise secondary memories (which are also called external memories or auxiliary memories), and the memories at this level connect to the processor through I/O channels of the memories, and use a data buffer to transmit data to the primary memories. The data in the secondary memories does not disappear even in the case without power supply (i.e., is non-volatile). The secondary memories may for example be various types of hard disks, optical disks or the like. The storage may further comprise a third-level storage device, i.e., a storage device that can be inserted into or pulled out from a computer directly, e.g., a mobile disk.

The input/output interface may be configured to receive data from the outside and output data to the outside, and it includes for example but not limited to a mouse, a trace ball, a touch pad, a keyboard, a scanner, a microphone, a user interface, a screen, a touch screen, a projector or the like. The network interface may comprise various physical network interface cards and network connection elements (e.g., routers, gateways or the like), and serve as interconnection between the mobility management entity 11 and the Evolved Packet Core Network 1 or other external networks (private local area networks or Internet networks). The network interface may enable the mobility management entity 11 to communicate with the Evolved Packet Core Network 1 or other external networks in a wired or wireless way depending on different requirements.

Referring to the specification No. TS24.301 of 3GPP, the transmission device 111 of the mobility management entity 11 may connect to the base stations eNB1 and eNB2 via an S1 interface. The S1 interface may comprise a control plane and a user plane, wherein the control plane is mainly used to transmit control instructions and the user plane is mainly used to transmit various kinds of data.

A main function of the access network discovery and selection function device 13 is to provide strategy information relevant to connection among the 3GPP networks and the non-3GPP networks (e.g., Wi-Fi networks), and reference may be made to specifications Nos. TS23.402, TS24.302 and 24.312 of 3GPP for specific contents thereof. Additionally, referring to the aforesaid specifications, the access network discovery and selection function device 13 may connect with the user equipment UE1 and exchange information with the user equipment UE1 via an S14 interface.

The packet data network (PDN) gateway 15 generally is a core component in the Evolved Packet Core Network 1 for performing data exchange, and it may bear the data exchange between the 3GPP networks and the non-3GPP networks. Referring to the specification No. TS 23.402 of 3GPP, the PDN gateway 15 may connect with the non-3GPP base station (e.g., the base station AP1 providing Wi-Fi) through an S2 interface.

The connection mentioned with reference to FIG. 1 above may be direct connection (i.e., connection not via other elements with specific functions) or indirect connection (i.e., connection via other elements with specific functions) depending on different requirements.

Still referring to FIG. 1, in the case where the user equipment UE1 currently only connects to the base station eNB1 (i.e., the serving base station) and the data and controlling of the user equipment UE1 are only managed by the base station eNB1, the transmission device 111 may obtain signal-to-noise ratio (SNR) information SNR generated by the user equipment UE1 with respect to a signal of a target base station (i.e., the base station eNB2 or the base station AP1) through the access network discovery and selection function device 13. Then, the computing device 113 may define a received signal strength indicator RSSI and a movement velocity indicator MVI for the user equipment UE1 and the target base station (i.e., the base station eNB2 or the base station AP1) according to the signal-to-noise ratio information SNR, and determine whether to hand over the user equipment UE1 from a serving base station (i.e., the base station eNB1) to the target base station (i.e., the base station eNB2 or the base station AP1) according to both of the received signal strength indicator RSSI and the movement velocity indicator MVI.

In some embodiments, the computing device 113 may compute a received signal strength of the user equipment UE1 according to the signal-to-noise ratio information SNR, and define the received signal strength as the received signal strength indicator RSSI. More particularly, the computing device 113 may compute the current channel noise and then compute the received signal strength by removing the channel noise from a signal-to-noise ratio generated currently with respect to the signal of the target base station (i.e., the base station eNB2 or the base station AP1) by the user equipment UE1, and define the received signal strength as the received signal strength indicator RSSI.

In some embodiments, the computing device 113 may determine a signal-to-noise ratio variation of the user equipment UE1 according to the signal-to-noise ratio information SNR and define the signal-to-noise ratio variation as the movement velocity indicator MVI. More particularly, the signal-to-noise ratio variation refers to the variation/difference between a first signal-to-noise ratio generated with respect to the signal of the target base station (i.e., the base station eNB2 or the base station AP1) by the user equipment UE1 at a first time point and a second signal-to-noise ratio generated with respect to the signal of the same target base station by the user equipment UE1 at a second time point later than the first time point (i.e., a value obtained by subtracting the first signal-to-noise ratio from the second signal-to-noise ratio). If the signal-to-noise ratio variation is a positive value (i.e., the second signal-to-noise ratio is greater than the first signal-to-noise ratio), then it is equivalent to that the user equipment UE1 moves towards the target base station (i.e., the base station eNB2 or the base station AP1); and if the signal-to-noise ratio variation is a negative value (i.e., the second signal-to-noise ratio is smaller than the first signal-to-noise ratio), then it is equivalent to that the user equipment UE1 moves away from the target base station (i.e., the base station eNB2 or the base station AP1). Additionally, a larger signal-to-noise ratio variation implies a faster movement velocity of the user equipment UE1, while a smaller signal-to-noise ratio variation implies a slower movement velocity of the user equipment UE1. Therefore, the computing device 113 may evaluate the movement velocity variation of the user equipment UE1 within a unit of time through the signal-to-noise ratio variation, and accordingly define the movement velocity indicator MVI.

In the case where the target base station is the base station eNB2, the computing device 113 may determine whether to switch data and controlling of the user equipment UE1 from the base station to eNB1 to the base station eNB2 according to both of the received signal strength indicator RSSI and the movement velocity indicator MVI because the base station eNB1 and the base station eNB2 belong to a same network (i.e., a homogeneous network).

Through the aforesaid switch, the base station eNB2 will completely replace the base station eNB1 and become the serving base station of the user equipment UE1, and both the data and the controlling of the user equipment UE1 are now managed by the base station eNB2.

In the case where the target base station is the base station AP1, the computing device 113 only determines whether to switch all or part of the data of the user equipment UE1 from the base station eNB1 to the base station AP1 according to both of the received signal strength indicator RSSI and the movement velocity indicator MVI because the base station eNB1 and the base station AP1 belong to different networks (i.e., heterogeneous networks). Through the aforesaid switch, both the base station eNB1 and the base station AP1 serve as the serving base stations of the user equipment UE1, and all or part of the data of the user equipment UE1 are now managed by the base station AP1 while the controlling of the user equipment UE1 is still managed by the base station eNB1 (i.e., data distribution).

In some embodiments, the transmission device 111 may further receive access delay information AD provided by the target base station (i.e., the base station eNB2 or the base station AP1) via the S1 interface, and the computing device 113 may further define an access delay indicator ADI for the user equipment UE1 and the target base station according to the access delay information AD, and then determine whether to hand over the user equipment UE1 from the base station eNB1 to the target base station according to the received signal strength indicator RSSI, the movement velocity indicator MVI and the access delay indicator ADI.

For example, in the case where the target base station is the base station eNB2, the transmission device 111 may obtain the access delay information AD from the base station eNB2 via the S1 interface. Moreover, in the case where the target base station is the base station AP1, the transmission device 111 may obtain the access delay information AD from the base station AP1 via the PDN gateway 15.

In some embodiments, the computing device 113 may determine an access delay time of the target base station (i.e., the base station eNB2 or the base station AP1) according to the access delay information AD and define the access delay time as the access delay indicator ADI. The access delay time may be different depending on different requirements, which may for example be but not limited to: the time to be waited for the user equipment UE1 to connect to the target base station and obtain an acknowledgement message (an ACK message) and the IP address.

In some embodiments, the transmission device 111 may further receive Quality of Service information QoS provided by the user equipment UE1 through the access network discovery and selection function device 13, and the computing device 113 may evaluate the access delay indicator ADI according to the Quality of Service information QoS when determining whether to hand over the user equipment UE1 from the base station eNB1 to the target base station (i.e., the base station eNB2 or the base station AP1).

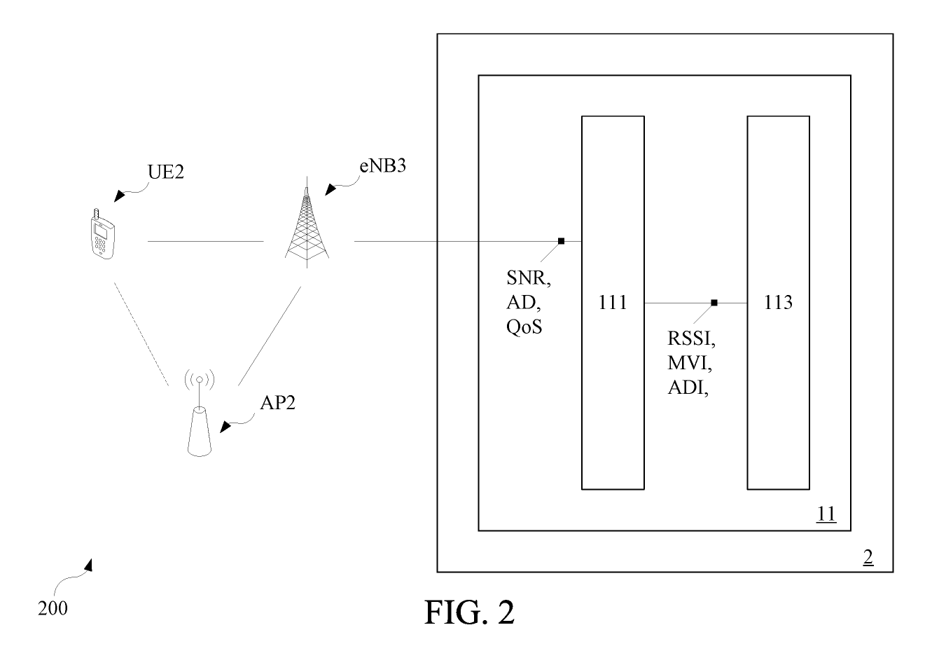

FIG. 2 illustrates another mobile communication system in one or more embodiments of the present invention. However, contents shown in FIG. 2 are only for purpose of illustrating embodiments of the present invention instead of limiting the present invention. Referring to FIG. 2, a mobile communication system 200 may comprise an Evolved Packet Core Network 2, a base station eNB3, a base station AP2, and a user equipment UE2.

The Evolved Packet Core Network 2 may be a core network in various mobile communication systems under the 3^{rd} Generation Partnership Project (3GPP). However, unlike the Evolved Packet Core Network 1, the Evolved Packet Core Network 2 does not comprise the access network discovery and selection function device 13 or does not use the access network discovery and selection function device 13. The base station eNB3 may be a base station in various mobile communication systems under the 3GPP, while the base station AP2 may be a base station in various mobile communication systems under the non-3GPP. Additionally, for the Evolved Packet Core Network 2, the base station AP1 may be a trusted or untrusted base station. For ease of description, elements in the Evolved Packet Core Network 2 that are not directly related to embodiments for explaining the present invention are omitted from depiction, but this does not mean that the Evolved Packet Core Network 2 does not comprise other elements that have not been described.

Referring to FIG. 1 to FIG. 2, like the Evolved Packet Core Network 1, the Evolved Packet Core Network 2 may comprise a mobility management entity 11, and the mobility management entity 11 may comprise a transmission device 111 for exchanging data and controlling instructions and a computing device 113 for calculating and storing data and generating instructions. Referring to the specification No. TS24.301 of 3GPP, the transmission device 111 of the mobility management entity 11 may connect to the base station eNB3 via the S1 interface. Additionally, referring to the specification No. TS 36.323 of 3GPP, the base station eNB3 and the base station AP2 may connect and exchange data with each other through an XW interface.

The connection mentioned with reference to FIG. 2 above may be direct connection (i.e., connection not via other elements with specific functions) or indirect connection (i.e., connection via other elements with specific functions) depending on different requirements. Still referring to FIG. 2, in the case where the user equipment UE2 currently only connects to the base station eNB3 (i.e., the serving base station) and both the data and the controlling of the user equipment UE2 are only managed by the base station eNB3, the transmission device 111 may obtain signal-to-noise ratio information SNR generated by the user equipment UE2 with respect to the signal of the base station AP2 (i.e., the target base station) through the base station eNB3. Then, the computing device 113 may define a received signal strength indicator RSSI and a movement velocity indicator MVI for the user equipment UE2 and the base station AP2 according to the signal-to-noise ratio information SNR, and determine whether to hand over the user equipment UE2 from the serving base station (i.e., the base station eNB3) to the target base station (i.e., the base station AP2) according to both of the received signal strength indicator RSSI and the movement velocity indicator MVI.

Because the base station eNB3 and the base station AP2 belong to different networks (i.e., heterogeneous networks), the computing device 113 only determines whether to switch all or part of the data of the user equipment UE2 from the base station eNB3 to the base station AP2 according to both of the received signal strength indicator RSSI and the movement velocity indicator MVI. Through the aforesaid switch, both the base station eNB3 and the base station AP2 serve as the serving base stations of the user equipment UE2, and all or part of the data of the user equipment UE2 are now managed by the base station AP2 while the controlling of the user equipment UE2 is still managed by the base station eNB3 (i.e., data distribution).

In some embodiments, the transmission device 111 may further obtain access delay information AD of the base station AP2 from the base station eNB3 via the S1 interface, and the computing device 113 may further define an access delay indicator ADI for the user equipment UE2 and the base station AP2 according to the access delay information AD, and then determine whether to hand over the user equipment UE2 from the base station eNB3 to the base station AP2 according to the received signal strength indicator RSSI, the movement velocity indicator MVI and the access delay indicator ADI.

In some embodiments, the transmission device 111 may further receive Quality of Service information QoS provided by the user equipment UE2 from the base station eNB3 via the S1 interface, and the computing device 113 may evaluate the access delay indicator ADI according to the Quality of Service information QoS when determining whether to hand over the user equipment UE2 from the base station eNB3 to the base station AP2.

In addition to the mobile communication systems illustrated in FIG. 1 and FIG. 2, the mobility management entity 11 may also be directly or equivalently applied to other mobile communication systems to achieve the same or similar effect. How to apply the mobility management entity 11 to other mobile communication systems shall be readily appreciated according to the above contents, and thus will not be further described herein.

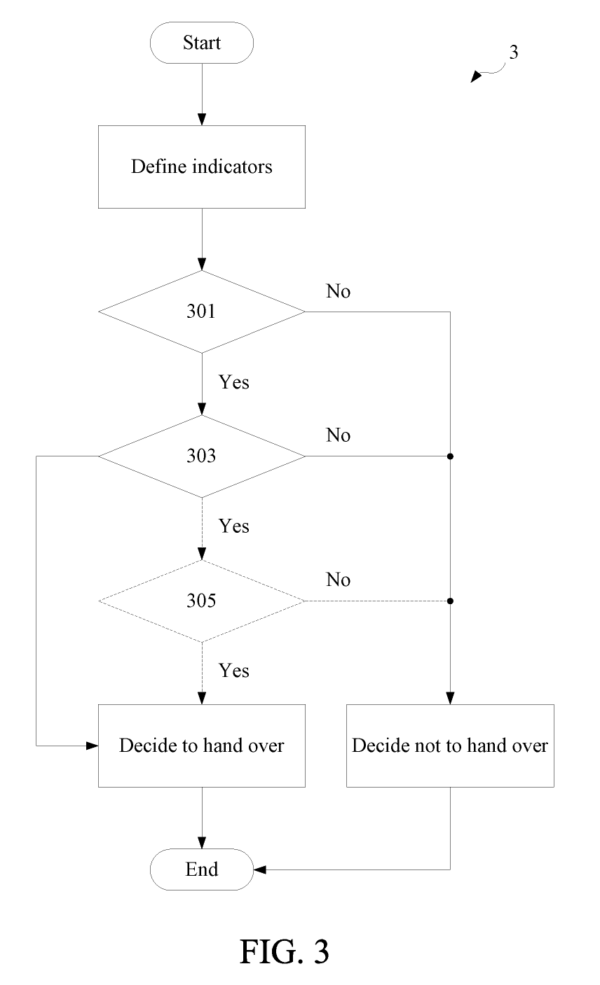

FIG. 3 illustrates a method of determining handover in one or more embodiments of the present invention. However, contents shown in FIG. 3 are only for purpose of illustrating embodiments of the present invention instead of limiting the present invention. Referring to FIG. 3, in a method 3 of determining handover, the computing device 113 may first define various indicators which include for example but not limited to: the received signal strength indicator RSSI, the movement velocity indicator MVI and the access delay indicator ADI or the like. Then, a same number of determining steps as the number of the indicators being defined are set according to the number of the indicators being defined.

For example, in the case where the computing device 113 defines the received signal strength indicator RSSI and the movement velocity indicator MVI, the method 3 of determining handover may comprise determining steps 301 and 302. In the determining step 301, the computing device 113 may determine whether the received signal strength indicator RSSI is greater than (or greater than or equal to) a received signal strength threshold that is preset, or determine whether the movement velocity indicator MVI is smaller than (or smaller than or equal to) a preset movement velocity threshold. If the determination result is yes, then the method enters into a determining step 303; and if the determination result is no, then the computing device 113 may decide not to hand over the user equipment (e.g., the user equipment UE1 of FIG. 1 or the user equipment UE2 of FIG. 2) from the serving base station (e.g., the base station eNB1 of FIG. 1 or the base station eNB3 of FIG. 2) to the target base station (e.g., the base station eNB2 or the base station AP1 of FIG. 1, or the base station AP2 of FIG. 2). In the determining step 303, the computing device 113 may determine whether the movement velocity indicator MVI is smaller than (or smaller than or equal to) the preset movement velocity threshold or determine whether the received signal strength indicator RSSI is greater than (or greater than or equal to) the received signal strength threshold that is preset. If the determination result is yes, then the computing device 113 may decide to hand over the user equipment from the serving base station to the target base station; and if the determination result is no, then the computing device 113 may decide not to hand over the user equipment from the serving base station to the target base station.

As another example, in the case where the computing device 113 defines the received signal strength indicator RSSI, the movement velocity indicator MVI and the access delay indicator ADI, the method 3 of determining handover may comprise a determining step 305 in addition to the determining steps 301 and 303. If the result of the determining step 303 is yes, then the method may enter into the determining step 305. In the determining step 305, the computing device 113 may determine whether the access delay indicator ADI is smaller than (or smaller than or equal to) a preset access delay threshold, wherein the preset access delay threshold may be preset by the computing device 113 according to the Quality of Service information QoS provided by the user equipment. If the determination result is yes, then the computing device 113 may decide to hand over the user equipment from the serving base station to the target base station; and if the determination result is no, then the computing device 113 may decide not to hand over the user equipment from the serving base station to the target base station. Positions of the determining steps 301, 303 and 305 are not limited, and may be exchanged arbitrarily.

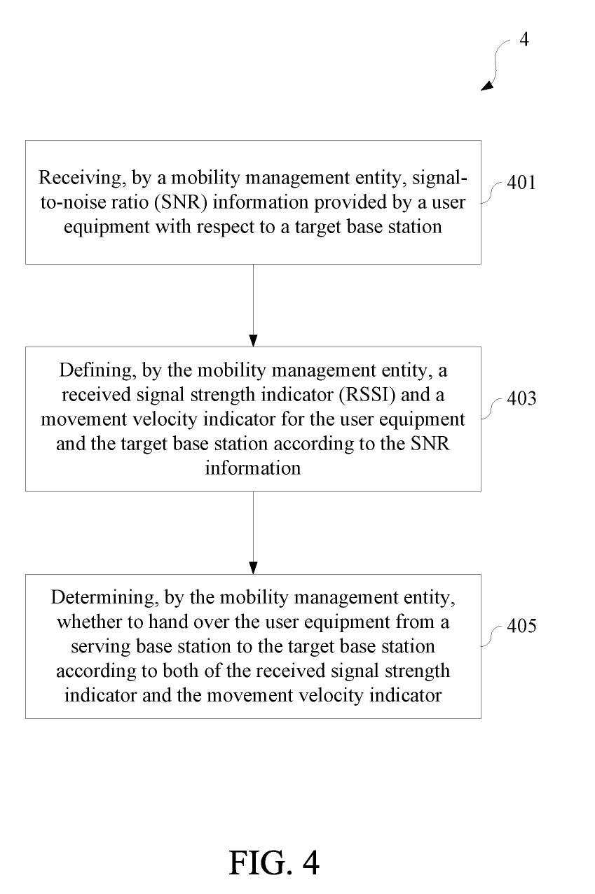

FIG. 4 illustrates a method of determining handover under an Evolved Packet Core Network in one or more embodiments of the present invention. However, contents shown in FIG. 4 are only for purpose of illustrating embodiments of the present invention instead of limiting the present invention. Referring to FIG. 4, a method 4 of determining handover under an Evolved Packet Core Network may comprise the following steps of:

receiving, by a mobility management entity, signal-to-noise ratio (SNR) information provided by a user equipment with respect to a target base station (labeled as 401);

defining, by the mobility management entity, a received signal strength indicator (RSSI) and a movement velocity indicator for the user equipment and the target base station according to the SNR information (labeled as 403); and

determining, by the mobility management entity, whether to hand over the user equipment from a serving base station to the target base station according to both of the received signal strength indicator and the movement velocity indicator (labeled as 405).

In some embodiments, in the method 4 of determining handover, the step of defining the movement velocity indicator may comprise:

determining an SNR variation of the user equipment according to the SNR information and defining the SNR variation as the movement velocity indicator by the mobility management entity.

In some embodiments, in the method 4 of determining handover, the step of defining the received signal strength indicator may comprise:

computing a received signal strength of the user equipment according to the SNR information and defining the received signal strength as the received signal strength indicator by the mobility management entity.

In some embodiments, the method 4 of determining handover may further comprise the following steps of:

receiving, by the mobility management entity, access delay information provided by the target base station; and

defining, by the mobility management entity, an access delay indicator for the user equipment and the target base station according to the access delay information;

wherein determining whether to hand over the user equipment from the serving base station to the target base station is to determine whether to hand over the user equipment from the serving base station to the target base station according to the received signal strength indicator, the movement velocity indicator and the access delay indicator.

In some embodiments, the method 4 of determining handover may further comprise the following steps of:

receiving, by the mobility management entity, access delay information provided by the target base station;

defining, by the mobility management entity, an access delay indicator for the user equipment and the target base station according to the access delay information;

receiving, by the mobility management entity, Quality of Service (QoS) information provided by the user equipment;

wherein determining whether to hand over the user equipment from the serving base station to the target base station is to determine whether to hand over the user equipment from the serving base station to the target base station according to the received signal strength indicator, the movement velocity indicator and the access delay indicator, and the access delay indicator is evaluated according to the QoS information when determining whether to hand over the user equipment from the serving base station to the target base station.

In some embodiments, the method 4 of determining handover may further comprise the following steps of:

receiving, by the mobility management entity, access delay information provided by the target base station;

defining, by the mobility management entity, an access delay indicator for the user equipment and the target base station according to the access delay information;

wherein determining whether to hand over the user equipment from the serving base station to the target base station is to determine whether to hand over the user equipment from the serving base station to the target base station according to the received signal strength indicator, the movement velocity indicator and the access delay indicator, and the step of defining the access delay indicator comprises: determining an access delay time of the target base station according to the access delay information and defining the access delay time as the access delay indicator by the mobility management entity.

In some embodiments, in the method 4 of determining handover, the serving base station may be a 3GPP base station, the target base station may be a non-3GPP base station, and the computing device may determine whether to switch data of the user equipment from the serving base station to the target base station according to the received signal strength indicator and the movement velocity indicator.

In some embodiments, in the method 4 of determining handover, the serving base station and the target base station may be each a 3GPP base station, and the computing device may determine whether to switch data and controlling of the user equipment from the serving base station to the target base station according to the received signal strength indicator and the movement velocity indicator.

In some embodiments, the method 4 of determining handover may be implemented under the Evolved Packet Core Network 1 or the Evolved Packet Core Network 2. All the corresponding steps for implementing the method 4 of determining handover under the Evolved Packet Core Network 1 or the Evolved Packet Core Network 2 shall be clearly appreciated by a person having ordinary skill in the art based on the above descriptions for the Evolved Packet Core Network 1 and the Evolved Packet Core Network 2, and thus relevant details thereof will not be further described herein.

In the aforesaid embodiments, the mobility management entity 11 may define the received signal strength indicator RSSI and the movement velocity indicator MVI for the user equipment according to the signal-to noise ratio information SNR of the target base station, and determine whether to hand over the user equipment from the serving base station to the target base station according to both of the received signal strength indicator RSSI and the movement velocity indicator MVI. The received signal strength indicator RSSI may be used to determine whether the signal strength of the target base station is good enough to stably maintain the connection between the target base station and the user equipment after the handover, thereby preventing the user equipment from being handed over to a base station of which the signal strength is excessively low. Additionally, the movement velocity indicator MVI may be used to determine whether the movement velocity of the user equipment can keep the user equipment in the coverage of the target base station within a period of time so as to prevent the user equipment from being handed over back to the serving base station or handed over to other base stations within a short period of time after being handed over to the target base station (i.e., the ping-pong effect), which would otherwise cause the waste of handover resources (i.e., without handover benefits). Therefore, in addition to the strength of the signal received by the user equipment from the target base station, the mobility management entity 11 further takes the movement velocity of the user equipment into consideration when determining whether to hand over. Therefore, as compared to the conventional handover mechanism, the aforesaid embodiments provide a more practical method of determining handover.

Additionally, the mobility management entity 11 may further define other types of indicators in addition to the received signal strength indicator RSSI and the movement velocity indicator MVI, and determine whether to hand over the user equipment from the serving base station to the target base station according to all the indicators being defined. For example, the mobility management entity 11 may further define an access delay indicator ADI, and determine whether to hand over the user equipment from the serving base station to the target base station according to the received signal strength indicator RSSI, the movement velocity indicator MVI and the access delay indicator ADI, wherein the access delay indicator ADI may be used to determine a delay time of accessing the target base station by the user equipment so as to prevent the user equipment from accessing an inefficient base station.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobility management entity under an Evolved Packet Core Network, comprising:
a transmission device, being configured to receive signal-to-noise ratio (SNR) information provided by a user equipment with respect to a target base station; and
a computing device electrically connected with the transmission device, being configured to define a received signal strength indicator (RSSI) and a movement velocity indicator for the user equipment and the target base station according to the SNR information, and determine whether to hand over the user equipment from a serving base station to the target base station according to both of the received signal strength indicator and the movement velocity indicator.

2. The mobility management entity of claim 1, wherein the computing device determines an SNR variation of the user equipment according to the SNR information and defines the SNR variation as the movement velocity indicator.

3. The mobility management entity of claim 1, wherein the computing device computes a received signal strength of the user equipment according to the SNR information, and defines the received signal strength as the received signal strength indicator.

4. The mobility management entity of claim 1, wherein:
the transmission device is further configured to receive access delay information provided by the target base station; and
the computing device is further configured to define an access delay indicator for the user equipment and the target base station according to the access delay information, and determines whether to hand over the user equipment from the serving base station to the target base station according to the received signal strength indicator, the movement velocity indicator and the access delay indicator.

5. The mobility management entity of claim 4, wherein:
the transmission device is further configured to receive Quality of Service (QoS) information provided by the user equipment; and
the computing device is further configured to evaluate the access delay indicator according to the QoS information when determining whether to hand over the user equipment from the serving base station to the target base station.

6. The mobility management entity of claim 4, wherein the computing device determines an access delay time of the target base station according to the access delay information and defines the access delay time as the access delay indicator.

7. The mobility management entity of claim 1, wherein:
the serving base station is a 3^{rd}-Generation Partnership Project (3GPP) base station, and the target base station is a non-3GPP base station; and
the computing device determines whether to switch data of the user equipment from the serving base station to the target base station according to the received signal strength indicator and the movement velocity indicator.

8. The mobility management entity of claim 1, wherein:
the serving base station and the target base station are each a 3GPP base station; and
the computing device determines whether to switch data and controlling of the user equipment from the serving base station to the target base station according to the received signal strength indicator and the movement velocity indicator.

9. A method of determining handover under an Evolved Packet Core Network, comprising:
receiving, by a mobility management entity, signal-to-noise ratio (SNR) information provided by a user equipment with respect to a target base station;
defining, by the mobility management entity, a received signal strength indicator (RSSI) and a movement velocity indicator for the user equipment and the target base station according to the SNR information; and
determining, by the mobility management entity, whether to hand over the user equipment from a serving base station to the target base station according to both of the received signal strength indicator and the movement velocity indicator.

10. The method of determining handover of claim 9, wherein defining the movement velocity indicator comprising:
determining an SNR variation of the user equipment according to the SNR information and defining the SNR variation as the movement velocity indicator by the mobility management entity.

11. The method of determining handover of claim 9, wherein defining the received signal strength indicator comprising:
computing a received signal strength of the user equipment according to the SNR information and defining the received signal strength as the received signal strength indicator by the mobility management entity.

12. The method of determining handover of claim 9, further comprising:
receiving, by the mobility management entity, access delay information provided by the target base station; and
defining, by the mobility management entity, an access delay indicator for the user equipment and the target base station according to the access delay information;
wherein determining whether to hand over the user equipment from the serving base station to the target base station is to determine whether to hand over the user equipment from the serving base station to the target base station according to the received signal strength indicator, the movement velocity indicator and the access delay indicator.

13. The method of determining handover of claim 12, further comprising:
receiving, by the mobility management entity, Quality of Service (QoS) information provided by the user equipment; and
evaluating, by the mobility management entity, the access delay indicator according to the QoS information when determining whether to hand over the user equipment from the serving base station to the target base station.

14. The method of determining handover of claim 12, wherein defining the access delay indicator comprises:
determining an access delay time of the target base station according to the access delay information and defining the access delay time as the access delay indicator by the mobility management entity.

15. The method of determining handover of claim 9, wherein:
the serving base station is a 3^{rd}-Generation Partnership Project (3GPP) base station, and the target base station is a non-3GPP base station; and
the mobility management entity determines whether to switch data of the user equipment from the serving base station to the target base station according to the received signal strength indicator and the movement velocity indicator.

16. The method of determining handover of claim 9, wherein:
the serving base station and the target base station are each a 3GPP base station; and
the mobility management entity determines whether to switch data and controlling of the user equipment from the serving base station to the target base station according to the received signal strength indicator and the movement velocity indicator.
